(19) United States
(12) Patent Application Publication
(10) Pub. No.: US 2025/0250193 A1
(43) Pub. Date: Aug. 7, 2025

(54) GLASS CERAMIC, MANUFACTURING METHOD THEREOF, AND DEVICE

(71) Applicant: Sumita Optical Glass, Inc., Saitama-shi, Saitama (JP)

(72) Inventor: Tatsuya TEZUKA, Saitama-shi, Saitama (JP)

(73) Assignee: Sumita Optical Glass, Inc., Saitama-shi, Saitama (JP)

(21) Appl. No.: 18/853,134

(22) PCT Filed: Mar. 28, 2023
(86) PCT No.: PCT/JP2023/012668

§ 371 Date: Oct. 1, 2024

(30) Foreign Application Priority Data
Apr. 25, 2022 (JP) 2022-071968

(51) Int. Cl. C03C 10/00

(52) U.S. Cl. CPC C03C 10/0009; C03C 2201/50; C03C 2203/50

(57) ABSTRACT

Provided is a transparent glass ceramic that has sufficiently low viscosity in the melt state, allows effective chemical strengthening by ion exchange, and has high internal strength. The glass ceramic has a composition including, in mol % by oxide equivalent, SiO₂: 55% or more to 70% or less; B₂O₃: over 0% to 10% or less; P₂O₅: over 0% to 5% or less; Li₂O: 18% or more to 30% or less; Na₂O: over 3% to 10% or less; K₂O: 0% or more to 5% or less; and ZrO₂: over 0% to 5% or less. The glass ceramic substantially does not include Al₂O₃.

### TECHNICAL FIELD

The present disclosure relates to a glass ceramic, a manufacturing method thereof, and a device.

### BACKGROUND

In recent years, cover glass made of glass material has been widely used as a protective member for displays and housings in mobile devices such as smartphones, smartwatches, and tablet terminals. There is a growing demand in particular for glass material used in such applications to have high strength and high transparency.

Here, chemical strengthening by ion exchange and crystallization are examples of methods used to increase the strength of glass materials.

The ion-exchange method is a method of increasing strength by forming compressive stress on the surface of a glass material by immersing the glass material in a melt of potassium nitrate, sodium nitrate, or the like and replacing the alkali component present on the glass surface with an alkali component having a larger ionic radius. This ion-exchange method has the advantages of forming higher compressive stress than the conventionally used air-cooling method or the like and of being applicable to objects of various shapes.

On the other hand, crystallization is a method of precipitating crystals inside the glass by heat treatment or the like and is a method of increasing the strength (for example, the hardness, fracture toughness, or the like) of the material itself, which cannot be achieved by the above-described ion exchange method. In particular, if the size of crystals precipitated inside the glass by crystallization is sufficiently small relative to the visible light wavelength (380 nm to 780 nm), the material can become a translucent glass ceramic.

In recent years, the combination of chemical strengthening by the ion-exchange method with crystallization has also been investigated to further increase strength as compared to conventional tempered glass.

In addition to strength and transparency, a growing demand also exists for the above-described glass materials to have a high degree of freedom of shape (the ability to be formed into complex shapes) from the perspectives of functionality and design characteristics. In this regard, the direct press method (hereinafter referred to as “DP”) is an example of a method for fabricating members with complex shapes, such as curved surfaces, using glass materials. In the DP method, a low-viscosity glass melt is received directly into a mold and pressed, which has the advantage of fabricating glass members at a relatively low cost. In order to apply such DP, the glass material is required to have low viscosity in the melt state.

Various high-strength glass or glass-ceramic materials have been reported.

For example, Patent Literature (PTL) 1 discloses tempered glass, with a surface compressive stress of 300 MPa or higher, that has been optimized in terms of chemical composition.

Also, PTL 2 discloses that glass ceramic containing a lithium silicate crystalline phase can have high mechanical strength.

PTL 3 discloses that crystallized glass containing one or more selected from RAl₂O₄, RTi₂O₅, R₂TiO₄, R₂SiO₄, RAl₂Si₂O8, and R₂Al₄Si₅O₁₈ (where R is selected from Zn, Mg, and Fe) as a crystalline phase can have high strength while having high visible light transmittance.

PTL 4 discloses that glass ceramic containing a lithium silicate crystalline phase and petalite crystalline phase can be chemically strengthened by ion exchange and can have high mechanical strength.

### CITATION LIST

### Patent Literature

PTL 1: JP 2018-104285 A
PTL 2: JP 2017-193534 A
PTL 3: JP 2017-001937 A
PTL 4: JP 2017-530933 A

### SUMMARY

### Technical Problem

However, the tempered glass described in PTL 1 only has increased resistance to cracking by formation of a compressive stress layer near the surface through ion exchange. Room for improvement still remains in terms of the strength (e.g., fracture toughness) of the material itself. In addition, the aforementioned toughened glass has an extremely high viscosity in the melt state, making it practically impossible to apply DP.

The glass ceramic described in PTL 2 is opaque or semi-transparent. In addition, the composition of the aforementioned glass-ceramic is not designed with ion exchange in mind. Room for improvement thus still remains in terms of effective strengthening by ion exchange.

Furthermore, both the crystallized glass described in PTL 3 and the glass ceramic described in PTL 4 have extremely high viscosity in the melt state, making it practically impossible to apply DP.

It is therefore an aim of the present disclosure to provide a transparent glass ceramic that has sufficiently low viscosity in the melt state, allows effective chemical strengthening by ion exchange, and has high internal strength, and a manufacturing method thereof. It is also an aim of the present disclosure to provide a device using the above-described glass ceramic.

### Solution to Problem

After careful study, I discovered that the desired glass ceramic could be obtained by adding specified amounts of B₂O₃, P₂O₅, Na₂O, and ZrO₂ to lithium silicate glass, and by not using Al₂O₃.

The main features of the present disclosure for resolving the above problem are as follows.

[1] A glass ceramic having a composition comprising:
in mol % by oxide equivalent,
SiO₂: 55% or more to 70% or less;
B₂O₃: over 0% to 10% or less;
P₂O₅: over 0% to 5% or less;
Li₂O: 18% or more to 30% or less;
Na₂O: over 3% to 10% or less;
K₂O: 0% or more to 5% or less; and
ZrO₂: over 0% to 5% or less,
wherein the glass ceramic substantially does not comprise Al₂O₃.

[2] The glass ceramic according to [1], wherein a temperature at which viscosity of the glass ceramic in a melt state exhibits a value of 100 dPa·s is 1200° C. or less.

[3] The glass ceramic according to [1] or [2], comprising at least one of a Li₂SiO₃ crystalline phase and a Li₂Si₂O₅ crystalline phase.

[4] The glass ceramic according to any one of [1] to [3], wherein at a thickness of 1 mm, the glass ceramic has a transmittance of 85% or more with respect to 400 nm wavelength light.

[5] The glass ceramic according to any one of [1] to [4], wherein Vickers hardness of the glass ceramic is 600 HV or more.

[6] The glass ceramic according to any one of [1] to [5], wherein a fracture toughness value of the glass ceramic is 1.00 MPa·m^{1/2} or more.

[7] The glass ceramic according to any one of [1] to [6], comprising a compressive stress layer on a surface of the glass ceramic.

[8] The glass ceramic according to [7], wherein the compressive stress layer has a surface compressive stress value of 400 MPa or more and a compressive stress depth of 50 μm or more.

[9] A method for manufacturing glass ceramic, the method comprising:
preparing a glass composition having a composition including
   in mol % by oxide equivalent,
   SiO₂: 55% or more to 70% or less,
   B₂O₃: over 0% to 10% or less,
   P₂O₅: over 0% to 5% or less,
   Li₂O: 18% or more to 30% or less,
   Na₂O: over 3% to 10% or less,
   K₂O: 0% or more to 5% or less, and
   ZrO₂: over 0% to 5% or less,
   the glass composition substantially not including Al₂O₃; and
applying crystallization treatment to the glass composition to obtain a glass ceramic.

[10] A device using the glass ceramic according to any of [1] to [8].

### Advantageous Effect

According to the present disclosure, a transparent glass ceramic that has sufficiently low viscosity in the melt state, allows effective chemical strengthening by ion exchange, and has high internal strength, and a manufacturing method thereof, can be provided. According to the present disclosure, a device using the above-described glass ceramic can also be provided.

### BRIEF DESCRIPTION OF THE DRAWINGS

In the accompanying drawings:

FIG. 1 is a diagram illustrating the X-ray diffraction pattern of a glass ceramic in Example 1;

FIG. 2 is a diagram illustrating the X-ray diffraction pattern of a glass ceramic in Example 2;

FIG. 3 is a diagram illustrating the transmission spectrum of the glass ceramic in Example 2; and

FIG. 4 is a diagram illustrating the residual stress profile of the glass ceramic in Example 2.

### DETAILED DESCRIPTION

### (Glass Ceramic)

The glass ceramic of an embodiment of the present disclosure (also referred to as the “glass ceramic of the present embodiment”) is described below in detail. The glass ceramic of the present embodiment has a composition including, in mol % by oxide equivalent,
SiO₂: 55% or more to 70% or less,
B₂O₃: over 0% to 10% or less,
P₂O₅: over 0% to 5% or less,
Li₂O: 18% or more to 30% or less,
Na₂O: over 3% to 10% or less,
K₂O: 0% or more to 5% or less, and
ZrO₂: over 0% to 5% or less,
   and the glass ceramic substantially does not include Al₂O₃.

The glass ceramic according to the present embodiment is a transparent glass ceramic that has sufficiently low viscosity in the melt state, allows effective chemical strengthening by ion exchange, and has high internal strength.

In the present specification, a “glass ceramic” refers to glass that partially contains crystals and that can be made by, for example, causing crystals to precipitate inside the glass. “Glass ceramic” is also referred to as “crystallized glass” in this field.

The glass ceramic of the present embodiment has a sufficiently low viscosity in the melt state by virtue of having the predetermined composition described above. Therefore, use of the glass ceramic of the present embodiment enables production of members with complex shapes by DP, can reduce costs, and enables mass production. In addition, the glass ceramic of the present embodiment has high ion-exchangeability due to the predetermined composition described above. Therefore, high strength can effectively be achieved by ion exchange (chemical strengthening). Furthermore, the glass ceramic of the present embodiment has transparency and high internal strength (strength of the material itself) due to the predetermined composition described above. Therefore, the glass ceramic of the present embodiment can be used as cover glass for mobile devices or the like that require transparency. As described above, the glass ceramic of the present embodiment has high adaptability as a glass-based material.

The glass ceramic of the present embodiment may contain other components (described below) other than the above-described components. However, from the viewpoint of more reliably expressing the desired characteristics, the glass ceramic of the present embodiment preferably has a composition consisting only of the above-described components (SiO₂, B₂O₃, P₂O₅, Li₂O, Na₂O, and ZrO₂ as essential components and only K₂O an optional component, in oxide notation).

Here, “consisting only of the above-described components” includes the case of impurity components other than the aforementioned components being unavoidably mixed in, specifically when the ratio of impurity components is 0.2 mol % or less.

First, the reasons for limiting the composition of the glass ceramic in the present embodiment to the above ranges are described.

The “%” indication regarding components refers to mol % by oxide equivalent, unless otherwise specified.

### <SiO₂>

In the glass ceramic of the present embodiment, SiO₂ is an important essential component that enables glass formation and forms the Li₂SiO₃ and/or Li₂Si₂O₅ crystalline phases that are mainly precipitated during crystallization. However, if the content exceeds 70%, the viscosity of the glass melt may increase significantly. On the other hand, if the content is less than 55%, the glass-forming ability may decrease, and transparency may decrease during crystallization. Therefore, in the glass ceramic of the present embodiment, the SiO₂ content is in a range of 55% or more to 70% or less. From the same perspective, the SiO₂ content in the glass ceramic of the present embodiment is preferably 56% or more, more preferably 57% or more, even more preferably 58% or more, preferably 69% or less, more preferably 67% or less, and even more preferably 66% or less.

<B₂O₃>

In the glass ceramic of the present embodiment, B₂O₃ is an important essential component that enables glass formation, lowers the viscosity of the glass melt, and furthermore promotes homogeneous crystallization. However, if the content exceeds 10%, the glass-forming ability may decrease, and transparency may decrease during crystallization. On the other hand, if B₂O₃ is not included, the effect of lowering the viscosity of the glass melt cannot be obtained, and transparency may decrease during crystallization. Therefore, in the glass ceramic of the present embodiment, the B₂O₃ content is in a range of over 0% to 10% or less. From the same perspective, the B₂O₃ content in the glass ceramic of the present embodiment is preferably 1% or more, more preferably 2% or more, preferably 9% or less, more preferably 8% or less, and even more preferably 7% or less.

<P₂O₅>

In the glass ceramic of the present embodiment, P₂O₅ is an important essential component that promotes homogeneous crystallization. However, if the content exceeds 5%, the glass-forming ability may decrease, and transparency may decrease during crystallization. On the other hand, if P₂O₅ is not included, transparency may decrease during crystallization. Therefore, in the glass ceramic of the present embodiment, the P₂O₅ content is in a range of over 0% to 5% or less. From the same perspective, the P₂O₅ content in the glass ceramic of the present embodiment is preferably 0.5% or more, more preferably 1% or more, preferably 4% or less, and more preferably 3% or less.

### <Li₂O>

In the glass ceramic of the present embodiment, Li₂O is an important essential component that significantly reduces the viscosity of the glass melt, forms the Li₂SiO₃ and/or Li₂Si₂O₅ crystalline phases that are mainly precipitated during crystallization, and furthermore is a source of Li+ ions that are exchanged with Na+ ions in the chemical strengthening treatment using NaNO₃ melt or the like. However, if the content exceeds 30%, the glass-forming ability may decrease, and transparency may decrease during crystallization. On the other hand, if the content is less than 18%, the effect of lowering the viscosity of the glass melt may be insufficient, and the strength improvement by the chemical strengthening treatment may not be sufficiently achieved. Therefore, in the glass ceramic of the present embodiment, the Li₂O content is in a range of 18% or more to 30% or less. From the same perspective, the Li₂O content in the glass ceramic of the present embodiment is preferably 19% or more, more preferably 20% or more, preferably 29% or less, more preferably 28% or less, and even more preferably 27% or less.

### <Na₂O>

In the glass ceramic of the present embodiment, Na₂O is an important essential component that reduces the viscosity of the glass melt, increases the glass-forming ability in combination with Li₂O, increases the ion-exchangeability between Na+ ions and Li+ ions in the chemical strengthening treatment using NaNO₃ melt or the like, and furthermore is a source of Na+ ions that are exchanged with K+ ions in the chemical strengthening treatment using KNO₃ melt or the like. However, if the content exceeds 10%, the glass-forming ability may decrease, and transparency may decrease during crystallization. On the other hand, if the content is 3% or less, the effect of lowering the viscosity of the glass melt may be insufficient, and the strength improvement by chemical strengthening treatment may not be sufficiently achieved (for example, formation of a compressive stress layer with a surface compressive stress value of 400 MPa or more may not be achieved). Therefore, in the glass ceramic of the present embodiment, the Na₂O content is in a range of over 3% to 10% or less. From the same perspective, the Na₂O content in the glass ceramic of the present embodiment is preferably 3.5% or more, more preferably 4% or more, even more preferably 4.5% or more, preferably 9% or less, and more preferably 8% or less.

### <K₂O>

In the glass ceramic of the present embodiment, K₂O is a component that reduces the viscosity of the glass melt and enhances the ion-exchangeability between K+ and Na+ ions in the chemical strengthening treatment using KNO₃ melt. However, if the content exceeds 5%, the glass-forming ability may decrease, and transmittance may decrease during crystallization. Therefore, in the glass ceramic of the present embodiment, the K₂O content is in a range of 0% or more to 5% or less. From the same perspective, the K₂O content in the glass ceramic of the present embodiment is preferably 0.2% or more, more preferably 0.7% or more, even more preferably 1.0% or more, preferably 4% or less, more preferably 3% or less, and even more preferably 2% or less.

### <ZrO₂>

In the glass ceramic of the present embodiment, ZrO₂ is an important essential component that promotes homogeneous crystallization. However, if the content exceeds 5%, the viscosity of the glass melt may increase, and the glass-forming ability may decrease. On the other hand, if ZrO₂ is not included, transparency may decrease during crystallization. Therefore, in the glass ceramic of the present embodiment, the ZrO₂ content is in a range of over 0% to 5% or less. From the same perspective, the ZrO₂ content in the glass ceramic of the present embodiment is preferably 1% or more, more preferably 2% or more, preferably 4.5% or less, and more preferably 4% or less.

<Al₂O₃>

It was discovered that even a small amount of Al₂O₃ in the glass ceramic of the present embodiment may significantly increase the viscosity of the glass melt. Therefore, the glass ceramic of the present embodiment substantially does not include Al₂O₃.

In the present disclosure, “substantially does not include” means not included intentionally.

### Other Components

Other components other than those described above can be included in the glass ceramic of the present embodiment, as long as the components do not deviate from the purpose. Examples of other components include coloring components such as V₂O₅, Cr₂O₃, MnO, MnO₂, FeO, Fe₂O₃, Co₂O₃, Co₃O₄, NiO, CuO, MoO₃, CeO₂, Pr₂O₃, Nd₂O₃, Sm₂O₃, Eu₂O₃, Tb₂O₃, Dy₂O₃, Ho₂O₃, Er₂O₃, and Tm₂O₃. The glass ceramic of the present embodiment can contain one or more coloring components, selected from these components, in small amounts (for example, an amount such that the total is 10 mol % or less by outer percentage). Further examples of the other components include defoaming components such as Sb₂O₃, and the glass ceramic of this embodiment can contain a small amount of such defoaming components (for example, an amount such that the total is 0.5 mol % or less by outer percentage).

The calculation of the composition of each component (SiO₂, Li₂O, and the like) in the glass ceramic of the present embodiment does not take into account the aforementioned other components.

Next, the various characteristics of the glass ceramic of the present embodiment are described.

The glass ceramic of the present embodiment has transparency, as described above. In greater detail, at a thickness of 1 mm, the glass ceramic of the present embodiment preferably has a transmittance of 85% or more with respect to 400 nm wavelength light. Therefore, the glass ceramic of the present embodiment is suitable for producing members that require transparency, such as front displays of mobile devices, for example.

The glass ceramic of the present embodiment has a sufficiently low viscosity in the melt state, as described above. In greater detail, the temperature at which the viscosity of the glass ceramic of the present embodiment in the melt state exhibits a value of 100 dPa·s is preferably 1200° C. or less. The temperature at which the viscosity of the glass ceramic of the present embodiment in the melt state exhibits a value of 100 dPa·s is more preferably 1180° C. or less, even more preferably 1160° C. or less.

When glass materials such as glass ceramic are in the melt state, the viscosity tends to be lower as the temperature is higher. Therefore, the temperature at which the viscosity exhibits a certain value (for example, 100 dPa·s) in the melt state is uniquely measured. The temperature at which the viscosity in the melt state exhibits a value of 100 dPa·s can be adjusted by, for example, adjusting the composition of the glass ceramic as appropriate.

The glass ceramic of the present embodiment has a high internal strength (strength of the material itself), as described above. In greater detail, the glass ceramic of the present embodiment preferably includes at least one of a Li₂SiO₃ crystalline phase and a Li₂Si₂O₅ crystalline phase. Both of the aforementioned Li₂SiO₃ crystalline phase and Li₂Si₂O₅ crystalline phase can significantly contribute to the improvement of internal strength (strength of the material itself).

The presence of the aforementioned Li₂SiO₃ crystalline phase and/or Li₂Si₂O₅ crystalline phases in glass ceramic can be identified from an X-ray diffraction pattern. The above Li₂SiO₃ crystalline phase and/or Li₂Si₂O₅ crystalline phase can be formed by adjusting the composition of the glass ceramic (in particular SiO₂ and Li₂O) and the conditions of crystallization, such as heat treatment, as appropriate.

With respect to the aforementioned internal strength, the glass ceramic of the present embodiment preferably has a Vickers hardness of 600 HV or more. The Vickers hardness of the glass ceramic of the present embodiment is more preferably 630 HV or more, and even more preferably 650 HV or more.

The Vickers hardness of the glass ceramic can, for example, be adjusted by adjusting the composition of the glass ceramic and the conditions of crystallization, such as heat treatment, as appropriate.

With respect to the aforementioned internal strength, the glass ceramic of the present embodiment preferably has a fracture toughness value of 1.00 MPa·m^{1/2} or more. The fracture toughness value of the glass ceramic of the present embodiment is more preferably 1.10 MPa·m^{1/2} or more, and even more preferably 1.20 MPa·m^{1/2} or more.

The fracture toughness value of the glass ceramic can be measured in accordance with JIS R1607:2015. The fracture toughness value of the glass ceramic can, for example, be adjusted by adjusting the composition of the glass ceramic and the conditions of crystallization, such as heat treatment, as appropriate.

The glass ceramic of the present embodiment preferably includes a compressive stress layer on the surface. As described above, since the glass ceramic of the present embodiment has high ion-exchangeability, the formation of a compressive stress layer on the surface via chemical strengthening by the ion-exchange method or the like can effectively achieve higher strength in the glass ceramic.

The compressive stress layer refers to a layer with a stress value exceeding 0 MPa. The formation of a compressive stress layer on the glass ceramic surface can be achieved by, for example, applying chemical strengthening treatment to the glass ceramic by the ion-exchange method, applying strain to the surface by rapid cooling, or the like.

In a case in which the glass ceramic of the present embodiment has a compressive stress layer on the surface, the compressive stress layer preferably has a surface compressive stress value of 400 MPa or more and a compressive stress depth of 50 μm or more. The surface compressive stress value of the glass ceramic of the present embodiment is more preferably 450 MPa or more, and even more preferably 500 MPa or more. Similarly, the compressive stress depth of the glass ceramic of the present embodiment is more preferably 55 μm or more, and even more preferably 60 μm or more.

The surface compressive stress value refers to the stress value at the outermost surface and can be measured using a surface stress meter. The compressive stress depth refers to the thickness of the layer where the stress value exceeds 0 MPa and can be measured using a scattered light photoelastic analyzer. The surface compressive stress value and compressive stress depth can be adjusted by adjusting the formation conditions of the compressive stress layer (for example, the time and temperature of the chemical strengthening treatment) as appropriate.

### (Method for Manufacturing Glass Ceramic)

Next, a method for manufacturing a glass ceramic of an embodiment of the present disclosure (also referred to as “the manufacturing method of the present embodiment”) is described in detail. The method for manufacturing glass ceramic includes:
preparing a glass composition having a composition including
   in mol % by oxide equivalent,
   SiO₂: 55% or more to 70% or less;
   B₂O₃: over 0% to 10% or less;
   P₂O₅: over 0% to 5% or less;
   Li₂O: 18% or more to 30% or less;
   Na₂O: over 3% to 10% or less;
   K₂O: 0% or more to 5% or less; and
   ZrO₂: over 0% to 5% or less,
   the glass composition substantially not including Al₂O₃ (glass preparation step); and
applying crystallization treatment to the glass composition to obtain a glass ceramic (crystallization step).

According to this manufacturing method, the above-described glass ceramic of the present embodiment can be manufactured. The manufacturing method of the present embodiment may also include other steps (such as a chemical strengthening step) as necessary.

### <Glass Preparation Step>

The glass preparation step is a step for preparing a glass composition having a predetermined composition. In the glass preparation step, for example, oxides, hydroxides, carbonates, nitrates, phosphates, and the like are weighed in predetermined proportions and thoroughly mixed as raw materials for each component contained in the aforementioned glass composition (and hence the glass ceramic) and for other components optionally included as needed, thereby yielding a glass preparation raw material. This glass preparation raw material is then placed into a melting vessel, that does not react with raw materials or the like (for example, a precious metal crucible), and the raw material is heated to 1200° C. to 1500° C. in an electric furnace to melt the raw material. The obtained melt is stirred for an appropriate time. Next, the result is clarified and homogenized in an electric furnace, cast in a mold preheated to an appropriate temperature, and then slowly cooled in an electric furnace to remove strain, thereby yielding the glass composition.

Alternatively, the glass preparation step can be performed by formation into a member having a predetermined shape by the direct pressing (DP) method. In greater detail, the above-described glass preparation raw material is heated in an electric furnace to 1200° C. to 1500° C. and melted. The resulting glass melt is then cooled to 1200° C. or less and poured into a mold having a predetermined shape by means of an outflow pipe or the like. Then, by using a shear blade or by dropping the mold straight down, a constricted part is formed by surface tension, the glass melt flow is separated, and a glass melt body of the desired mass is formed. Subsequently, the glass melt body is cooled in the mold and pressed to obtain a glass member (glass composition) with a predetermined shape.

This type of molding by DP is particularly suitable for making relatively large and complex-shaped members, such as mobile device housings.

A specific description of the composition (by oxide equivalent) of the aforementioned glass composition is substantially the same as the above description of the composition of the glass ceramic.

### <Crystallization Step>

The crystallization step is a step of applying crystallization treatment to the aforementioned glass composition to obtain a glass ceramic. In the crystallization step, for example, crystals are precipitated to obtain a glass ceramic by heat-treating the aforementioned glass composition in a temperature range that is higher than the glass transition temperature but does not melt the glass composition. From the perspective of obtaining the desired glass ceramic more reliably, the temperature of the heat treatment is preferably 400° C. to 700° C. The duration of the heat treatment is preferably from 1 to 20 hours from the perspective of more reliably causing the desired crystals to precipitate. In addition, as heat treatment in the crystallization step, it is preferable from the perspective of increasing transparency to perform multi-step heat treatment, such as heat treatment at a relatively low temperature of 400° C. to 500° C., followed by heat treatment at a relatively high temperature of 600° C. to 700° C.

In addition to the above-described heat treatment, laser annealing treatment can also be performed in the crystallization process.

Alternatively, crystallization treatment may be applied at the time of formation into a member having a predetermined shape by the direct pressing (DP) method described above as the glass preparation step. For example, in a case in which the cooling rate in the temperature range of 400° C. to 700° C. is slow during formation by DP, crystals may precipitate in the glass member (glass composition).

### <Chemical Strengthening Step>

In the manufacturing method of the present embodiment, a step of applying chemical strengthening treatment using the ion-exchange method to the glass ceramic obtained in the crystallization step may be further performed (chemical strengthening step). The chemical strengthening treatment is a treatment to immerse the aforementioned glass ceramic in a heated melt of NaNO₃, KNO₃, or the like. As a result of this process, Li+ ions and Na+ ions near the surface of the glass ceramic are replaced by ions with larger ionic radii, thus forming a compressive stress layer on the surface of the glass ceramic.

In the chemical strengthening treatment, from the perspective of increasing the surface compressive stress value and the compressive stress depth, i.e., for further chemical strengthening, it is preferable to perform a multi-step immersion treatment in which the glass ceramic is immersed in a heated NaNO₃ melt and then immersed in a heated KNO₃ melt.

In the chemical strengthening treatment, from the perspective of increasing the surface compressive stress value and the compressive stress depth, i.e., for further chemical strengthening, the temperature of the melt of NaNO₃, KNO₃, or the like is preferably 360° C. to 440° C. From the perspective of suppressing the decrease in the surface compressive stress value, the immersion time during the chemical strengthening treatment is preferably 24 hours or less.

### (Device)

A device in an embodiment of the present disclosure uses the above-described glass ceramic. In other words, the device in an embodiment of the present disclosure includes the above-described glass ceramic as a member.

The aforementioned device is typically a device that includes a member for which at least one of strength, transparency, and freedom of shape is required (for example, a protective member for a display or housing, or a protective member for a front display or optical device). Examples of the aforementioned device include electronic devices and optical devices. Electronic devices include notebook PCs, smartphones, smartwatches, tablet terminals, and the like. Optical devices include cameras, telescopes, projectors, in-vehicle cameras, in-vehicle sensors, and the like.

### EXAMPLES

The present disclosure will now be described in detail based on Examples and Comparative Examples, but the present disclosure is not limited to these Examples.

### (Preparation of Glass Compositions)

Oxides, hydroxides, carbonates, nitrates, phosphates, and the like corresponding to the raw materials for each of the ingredients listed in Tables 1 and 2 were weighed to become 100 g after vitrification, mixed thoroughly, placed into a platinum crucible, and melted in an electric furnace at 1200° C. to 1500° C. for 1 to 2 hours to obtain a melt.

The temperature at which the viscosity of the obtained melt exhibited a value of 100 dPa·s was measured by a rotating cylinder method. Specifically, a platinum cylinder was immersed in the melt, and the temperature at which the viscosity exhibited a value of 100 dPa·s was measured based on the rotational force (torque) received by the cylinder when the cylinder was rotated. The results are listed in Tables 1 and 2.

For the examples in which the aforementioned temperature exceeded 1200° C., the viscosity in the melt state was determined to be poor, and the process was terminated without proceeding to the operations and evaluations after obtaining the glass.

The aforementioned melt was then stirred for an appropriate time to homogenize and clarify the melt, which was then cast into a mold preheated to an appropriate temperature. The glass (glass composition) was then slowly cooled in an electric furnace to remove strain.

The examples that did not vitrify were determined to be of poor quality, and the process was terminated without proceeding to the subsequent operations and evaluations. (In Tables 1 and 2, the glass compositions that vitrified are designated “A”, and those that did not vitrify are designated “B”.)

### (Crystallization Treatment)

The aforementioned glass was then subjected to one or multiple steps of heat treatment in an electric furnace at 700° C. or lower for 1 to 20 hours (conditions are listed in Tables 1 and 2). As a result, crystals were precipitated inside the glass, and a glass ceramic was obtained. The conditions of heat treatment in each example were determined appropriately according to various circumstances such as glass composition.

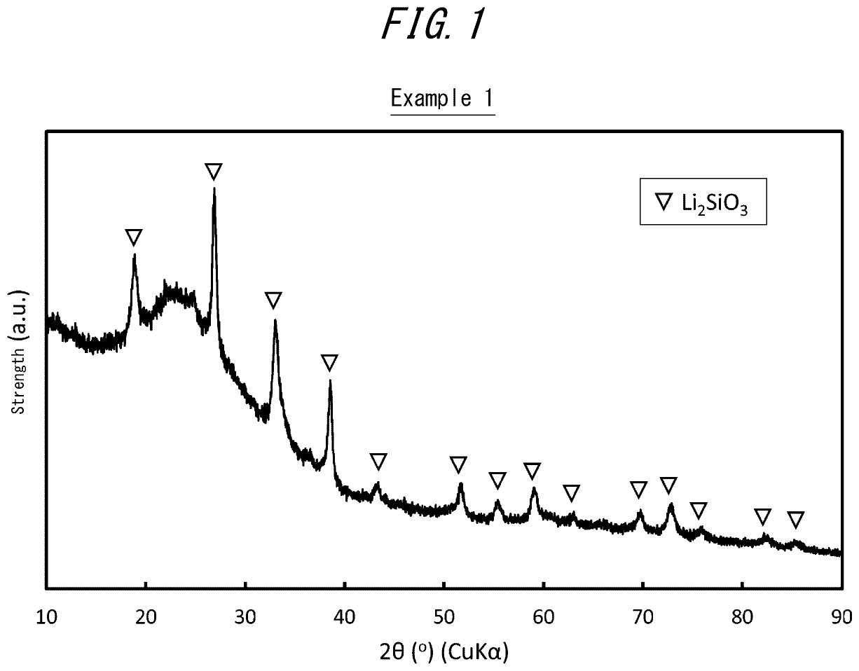

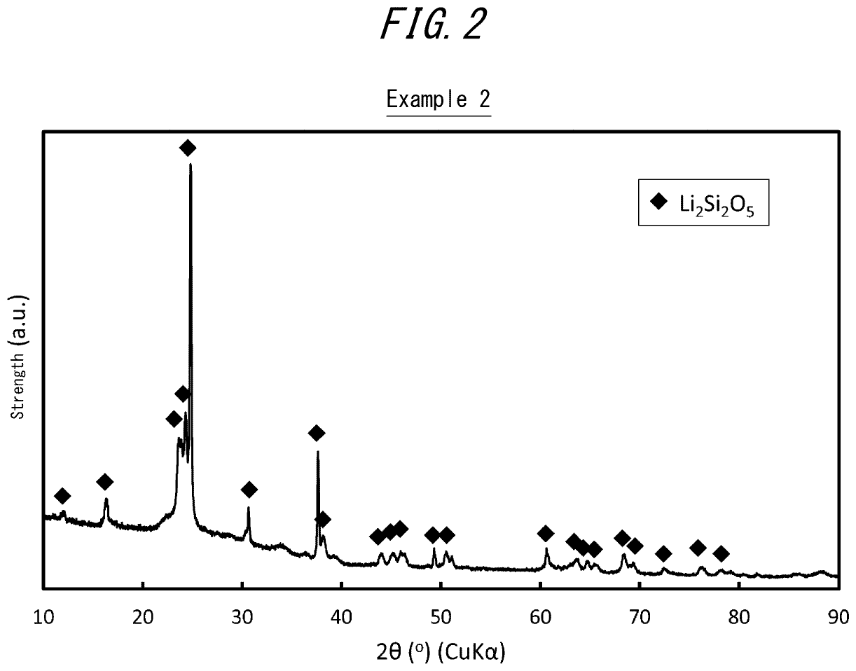

The precipitated crystalline phase of the resulting glass ceramic was identified from the X-ray diffraction pattern obtained using an X-ray diffractometer (ULTIMA4, produced by Rigaku Corporation). The results are listed in Tables 1 and 2. In general, only precipitation of the Li₂SiO₃ and/or Li₂Si₂O₅ crystalline phases was confirmed in the Examples, but in some Comparative Examples, precipitation of crystalline phases other than Li₂SiO₃ and Li₂Si₂O₅ crystalline phases was also confirmed. For reference, the X-ray diffraction pattern of the glass ceramic in Example 1 is illustrated in FIG. 1, and the X-ray diffraction pattern of the glass ceramic in Example 2 is illustrated in FIG. 2.

The transparency of the resulting glass ceramic was evaluated according to the following criteria by measuring the transmittance, at a thickness of 1 mm, with respect to light having a 400 nm wavelength using a spectrophotometer (U-4100, produced by Hitachi, Ltd.). The results are listed in Tables 1 and 2.
A: Transmittance of 85% or more
B: Transmittance of less than 85%

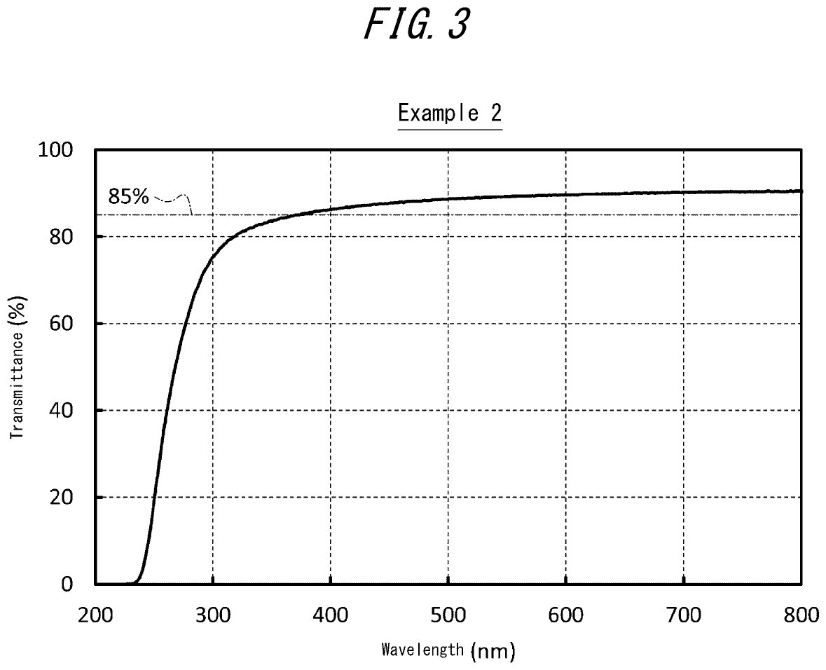

For reference, the transmission spectrum of the glass ceramic in Example 2, at a thickness of 1 mm, with respect to light having 200 to 800 nm wavelengths is illustrated in FIG. 3.

The examples for which the transmittance was less than 85% were determined to have poor transparency, and the process was terminated without proceeding to the subsequent operations and evaluations.

The Vickers hardness of the resulting glass ceramic was measured using a Vickers hardness tester (MMT-X3, produced by Matsuzawa Co., Ltd.). The results are listed in Tables 1 and 2. A higher value indicates higher internal strength (strength of the material itself).

The fracture toughness value of the obtained glass ceramic was measured using the IF method according to JIS R1607:2015, “Testing methods for fracture toughness of fine ceramics at room temperature”. The results are listed in Tables 1 and 2. A higher value indicates higher internal strength (strength of the material itself).

### (Chemical Strengthening Treatment)

Next, the aforementioned glass ceramic was subjected to chemical strengthening treatment. Specifically, the glass ceramic was immersed in a melt of NaNO₃ heated to 360° C. to 440° C. for 24 hours or less and then immersed in a melt of KNO₃ heated to 360° C. to 440° C. for 24 hours or less (conditions are listed in Tables 1 and 2). A compressive stress layer was thereby formed on the surface of the glass ceramic. The conditions of the chemical strengthening treatment in each example were determined appropriately according to various circumstances such as the glass composition and the conditions of the heat treatment performed in the previous step.

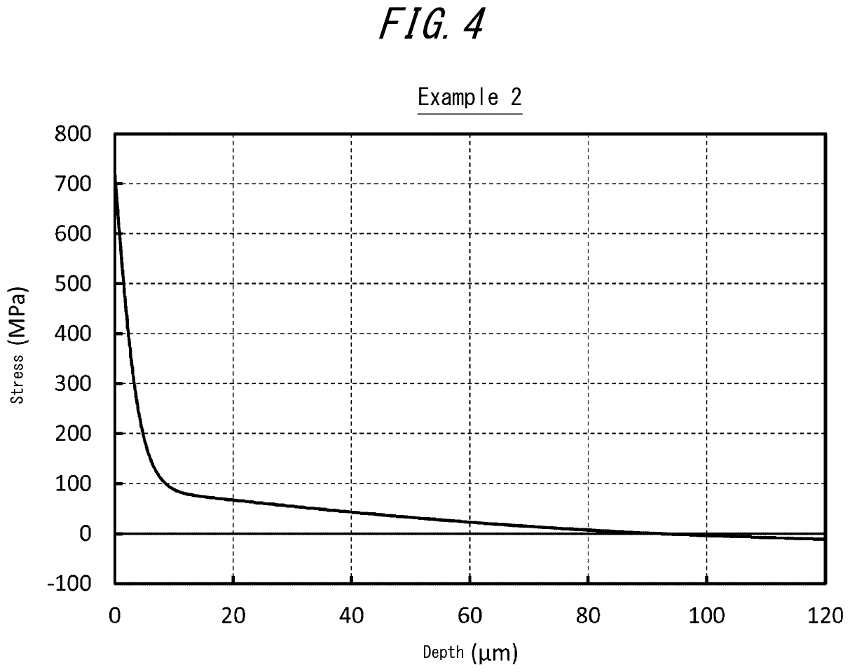

The surface compressive stress value and the compressive stress depth were measured for the glass ceramic on which the compressive stress layer was formed. Specifically, a glass surface stress meter (FSM-6000LEUV, produced by Orihara Manufacturing Co., Ltd.) was used to measure the surface compressive stress value. A scattered light photoelastic analyzer (SLP-2000, produced by Orihara Manufacturing Co., Ltd.) was used to measure the compressive stress depth. The results are listed in Tables 1 and 2. For reference, the residual stress profiles calculated using synthesis software (Pmc, produced by Orihara Manufacturing Co., Ltd.) from the values measured by the aforementioned glass surface stress meter and the scattered light photoelastic analyzer for the glass ceramic of Example 2 are illustrated in FIG. 4.

TABLE 1

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| SiO₂ | [mol %] | 64.90 | 60.98 | 64.59 | 62.98 | 62.20 | 57.18 | 61.61 | 60.10 | 60.47 | 67.54 |
| B₂O₃ | | 2.40 | 2.45 | 2.39 | 2.45 | 2.39 | 4.50 | 2.36 | 8.69 | 2.33 | 2.15 |
| P₂O₅ | | 1.92 | 1.78 | 1.91 | 1.89 | 1.91 | 2.01 | 1.90 | 1.80 | 1.85 | 1.40 |
| Al₂O₃ | | 0 | 0 | 0 | 0 | 0 | 0 | 0 | 0 | 0 | 0 |
| Li₂O | | 24.05 | 23.57 | 23.93 | 23.50 | 23.92 | 24.58 | 23.70 | 22.84 | 23.26 | 23.00 |
| Na₂O | | 4.81 | 6.62 | 4.78 | 6.13 | 6.79 | 6.55 | 6.73 | 4.76 | 6.60 | 4.25 |
| K₂O | | 0.96 | 1.41 | 0.96 | 0.00 | 1.34 | 2.03 | 1.33 | 0.94 | 1.30 | 0.81 |
| ZrO₂ | | 0.96 | 3.19 | 1.44 | 3.05 | 1.45 | 3.15 | 2.37 | 0.87 | 4.19 | 0.85 |
| Total | | 100.00 | 100.00 | 100.00 | 100.00 | 100.00 | 100.00 | 100.00 | 100.00 | 100.00 | 100.00 |
| Melt temperature [° C.] | | 1178 | 1133 | 1155 | 1142 | 1135 | 1079 | 1119 | 1100 | 1154 | 1196 |
| exhibiting viscosity | | | | | | | | | | | |
| of 100 dPa · s | | | | | | | | | | | |
| Vitrifiability | | A | A | A | A | A | A | A | A | A | A |
| Heat treatment conditions | | 540-5 | 490-5, | 540-5 | 490-4, | 540-5 | 480-4, | 480-4, | 540-5 | 490-5, | 490-15, |
| (temperature | | | 620-2 | | 510-4, | | 590-4 | 505-4, | | 600-2 | 600-2 |
| [° C.] - time [hr]) | | | | | 600-4 | | | 610-4 | | | |
| Precipitated crystalline | | Li₂SiO₃ | Li₂Si₂O₅ | Li₂SiO₃ | Li₂Si₂O₅ | Li₂SiO₃ | Li₂SiO₃, | Li₂Si₂O₅ | Li₂SiO₃ | Li₂SiO₃, | Li₂SiO₃, |
| phase | | | | | | | Li₂SiO₅ | | | Li₂Si₂O₅ | Li₂Si₂O₅ |
| Transparency | | A | A | A | A | A | A | A | A | A | A |
| Vickers hardness [HV] | | 686 | 780 | 741 | 782 | 735 | 645 | 851 | 631 | 814 | 774 |
| Fracture toughness value | | 1.16 | 2.73 | 1.34 | 2.30 | 1.22 | 1.60 | 2.44 | 1.30 | 2.12 | 1.89 |
| [MPa · m^{1/2}] | | | | | | | | | | | |
| Chemical strengthening | | NaNO₃- | NaNO₃- | NaNO₃- | NaNO₃- | NaNO₃- | NaNO₃- | NaNO₃- | NaNO₃- | NaNO₃- | NaNO₃- |
| treatment conditions | | 380-6, | 400-16, | 380-4, | 400-8, | 360-8, | 360-8, | 400-16, | 380-6, | 400-8, | 420-8, |
| (melt - temperature | | KNO₃- | KNO₃- | KNO₃- | KNO₃- | KNO₃- | KNO₃- | KNO₃- | KNO₃- | KNO₃- | KNO₃ |
| [° C.] - | | 370-4 | 380-6 | 360-2 | 380-6 | 340-4 | 340-4 | 380-8 | 370-6 | 380-6 | 400-4 |
| time[hr]) | | | | | | | | | | | |
| Surface compressive | | 551 | 719 | 574 | 695 | 535 | 525 | 468 | 520 | 577 | 643 |
| stress value | | | | | | | | | | | |
| [MPa] | | | | | | | | | | | |
| Compressive | | 123 | 92 | 110 | 97 | 131 | 129 | 114 | 131 | 94 | 121 |
| stress depth | | | | | | | | | | | |
| [μm] | | | | | | | | | | | |

| | | Exam- | Exam- | Exam- | Exam- | Exam- | Exam- | Exam- | Exam- | Exam- | Exam- |
|---|---|---|---|---|---|---|---|---|---|---|---|
| | | ple 11 | ple 12 | ple 13 | ple 14 | ple 15 | ple 16 | ple 17 | ple 18 | ple 19 | ple 20 |
| SiO₂ | [mol %] | 64.11 | 61.38 | 63.14 | 63.00 | 66.99 | 62.28 | 63.40 | 64.59 | 61.20 | 64.30 |
| B₂O₃ | | 2.33 | 2.61 | 1.41 | 2.20 | 2.39 | 1.88 | 2.05 | 2.39 | 2.65 | 2.38 |
| P₂O₅ | | 1.10 | 2.13 | 1.91 | 3.77 | 1.91 | 1.64 | 1.88 | 1.91 | 1.92 | 1.90 |
| Al₂O₃ | | 0 | 0 | 0 | 0 | 0 | 0 | 0 | 0 | 0 | 0 |
| LiO | | 24.15 | 23.76 | 24.02 | 23.50 | 21.53 | 28.36 | 22.57 | 19.14 | 23.75 | 23.81 |
| Na₂O | | 5.19 | 6.92 | 5.02 | 4.44 | 4.78 | 3.95 | 5.19 | 8.80 | 6.95 | 4.76 |
| K₂O | | 0.99 | 0.00 | 1.46 | 1.51 | 0.96 | 0.85 | 3.95 | 1.73 | 0.00 | 0.95 |
| ZrO₂ | | 2.13 | 3.20 | 3.04 | 1.58 | 1.44 | 1.04 | 0.96 | 1.44 | 3.53 | 1.90 |
| Total | | 100.00 | 100.00 | 100.00 | 100.00 | 100.00 | 100.00 | 100.00 | 100.00 | 100.00 | 100.00 |
| Melt temperature [° C.] | | 1166 | 1133 | 1163 | 1140 | 1189 | 1075 | 1157 | 1170 | 1166 | 1161 |
| exhibiting viscosity | | | | | | | | | | | |
| of 100 dPa · s | | | | | | | | | | | |
| Vitrifiability | | A | A | A | A | A | A | A | A | A | A |
| Heat treatment conditions | | 500-2, | 490-5, | 490-4, | 540-8 | 570-5 | 470-4. | 560-10 | 570-5 | 490-5, | 550-5 |
| (temperature | | 610-2 | 570-5 | 515-4, | | | 495-4. | | | 600-2 | |
| [° C.] - time [hr]) | | | | 620-4 | | | 590-4 | | | | |
| Precipitated crystalline | | Li₂SiO₅ | Li₂SiO₃ | Li₂Si₂O₅ | Li₂SiO₃ | Li₂SiO₃ | Li₂Si₂O₅ | Li₂SiO₃ | Li₂SiO₃ | Li₂SiO₃, | Li₂SiO₃ |
| phase | | | | | | | | | | Li₂Si₂O₅ | |
| Transparency | | A | A | A | A | A | A | A | A | A | A |
| Vickers hardness [HV] | | 766 | 668 | 803 | 638 | 702 | 729 | 649 | 699 | 745 | 693 |
| Fracture toughness value | | 2.09 | 1.56 | 2.22 | 1.29 | 1.23 | 2.11 | 1.66 | 1.47 | 1.99 | 1.25 |
| [MPa · m^{1/2}] | | | | | | | | | | | |
| Chemical strengthening | | NaNO₃- | NaNO₃- | NaNO₃- | NaNO₃- | NaNO₃- | NaNO₃- | NaNO₃- | NaNO₃ | NaNO₃- | NaNO₃- |
| treatment conditions | | 400-8, | 400-16, | 400-8, | 400-4, | 390-12, | 360-8, | 400-4, | 400-4, | 400-16, | 390-2, |
| (melt - temperature | | KNO₃- | KNO₃- | KNO₃- | KNO₃- | KNO₃- | KNO₃- | KNO₃- | KNO₃- | KNO₃- | KNO₃- |
| [° C.] - | | 380-4 | 380-6 | 380-8 | 380-4 | 380-2 | 340-2 | 380-4 | 380-4 | 380-6 | 370-2 |
| time[hr]) | | | | | | | | | | | |
| Surface compressive | | 644 | 530 | 623 | 661 | 581 | 606 | 683 | 603 | 606 | 566 |
| stress value | | | | | | | | | | | |
| [MPa] | | | | | | | | | | | |
| Compressive | | 116 | 136 | 91 | 107 | 134 | 99 | 118 | 118 | 112 | 106 |
| stress depth | | | | | | | | | | | |
| [μm] | | | | | | | | | | | |

TABLE 2

| | | Compar- | Compar- | Compar- | Compar- | Compar- | Compar- | Compar- | Compar- | Compar- |
|---|---|---|---|---|---|---|---|---|---|---|
| | | ative | ative | ative | ative | ative | ative | ative | ative | ative |
| | | Example 1 | Example 2 | Example 3 | Example 4 | Example 5 | Example 6 | Example 7 | Example 8 | Example 9 |
| SiO₂ | [mol %] | 58.52 | 53.11 | 70.10 | 67.24 | 61.58 | 64.33 | 62.79 | 59.25 | 63.57 |
| B₂O₃ | | 11.80 | 7.75 | 0.15 | 0 | 2.22 | 1.84 | 2.41 | 2.04 | 3.08 |
| P₂O₅ | | 1.60 | 2.12 | 0.83 | 2.24 | 7.01 | 0 | 1.50 | 1.77 | 1.79 |
| Al₂O₃ | | 0 | 0 | 4.27 | 0 | 0 | 0 | 0 | 0 | 0 |
| Li₂O | | 20.98 | 25.51 | 21.42 | 21.81 | 23.01 | 23.46 | 22.01 | 31.76 | 24.08 |
| Na₂O | | 3.46 | 5.54 | 1.48 | 4.51 | 4.00 | 4.32 | 3.27 | 3.37 | 1.85 |
| K₂O | | 1.55 | 2.22 | 0 | 1.36 | 0.99 | 2.35 | 7.11 | 0.90 | 3.50 |
| ZrO₂ | | 2.09 | 3.75 | 1.75 | 2.84 | 1.19 | 3.70 | 0.91 | 0.91 | 2.13 |
| Total | | 100.00 | 100.00 | 100.00 | 100.00 | 100.00 | 100.00 | 100.00 | 100.00 | 100.00 |
| Melt temperature | | 1055 | 1021 | 1330 | 1265 | 1147 | 1169 | 1160 | 1020 | 1186 |
| [° C.] exhibiting | | | | | | | | | | |
| viscosity | | | | | | | | | | |
| of 100 dPa · s | | | | | | | | | | |
| Vitrifiability | | A | A | A | A | B | A | A | A | A |
| Heat treatment | | 540-5 | 540-5 | — | — | — | 540-5 | 540-5 | 540-5 | 490-4, |
| conditions | | | | | | | | | | 600-4 |
| (temperature | | | | | | | | | | |
| [° C.] - time [hr]) | | | | | | | | | | |
| Precipitated crystalline | | Li₂SiO₃ | Li₂SiO₃ | | | | Li₂SiO₃ | Li₂SiO₃ | Li₂SiO₃ | Li₂SiO₃, |
| phase | | and other | | | | | | and other | | Li₂Si₂O₅ |
| Transparency | | B | B | | | | B | B | B | A |
| Vickers hardness [HV] | | | | | | | — | — | — | 710 |
| Fracture toughness value | | | | | | | | | | 1.85 |
| [MPa · m]^{1/2} | | | | | | | | | | NaNO₃- |
| Chemical strengthening | | | | | | | | | | 400-8, |
| treatment conditions | | | | | | | | | | KNO₃- |
| (melt - | | | | | | | | | | 380-2 |
| temperature [° C.] - | | | | | | | | | | |
| time [hr]) | | | | | | | | | | |
| Surface compressive | | | | | | | | | | 370 |
| stress value | | | | | | | | | | |
| [MPa] | | | | | | | | | | |
| Compressive | | | | | | | | | | 106 |
| stress depth | | | | | | | | | | |
| [μm] | | | | | | | | | | |

| | | Compar- | Compar- | Compar- | Compar- | Compar- | Compar- |
|---|---|---|---|---|---|---|---|
| | | ative | ative | ative | ative | ative | ative |
| | | Example 10 | Example 11 | Example 12 | Example 13 | Example 14 | Example 15 |
| SiO₂ | [mol %] | 61.18 | 71.98 | 66.07 | 61.10 | 64.28 | 64.25 |
| B₂O₃ | | 1.95 | 1.15 | 3.88 | 2.84 | 3.91 | 1.69 |
| P₂O₅ | | 1.67 | 1.65 | 2.02 | 1.79 | 1.97 | 1.46 |
| Al₂O₃ | | 0 | 0 | 0 | 0 | 0 | 5.89 |
| Li₂O | | 20.22 | 20.64 | 16.12 | 22.28 | 23.69 | 21.22 |
| Na₂O | | 12.52 | 3.75 | 5.47 | 3.52 | 3.73 | 3.49 |
| K₂O | | 1.40 | 0 | 3.03 | 0.96 | 2.42 | 0.86 |
| ZrO₂ | | 1.06 | 0.83 | 3.41 | 7.51 | 0 | 1.14 |
| Total | | 100.00 | 100.00 | 100.00 | 100.00 | 100.00 | 100.00 |
| Melt temperature | | 1109 | 1315 | 1259 | 1207 | 1129 | 1272 |
| [° C.] exhibiting | | | | | | | |
| viscosity | | | | | | | |
| of 100 dPa · s | | | | | | | |
| Vitrifiability | | A | A | A | B | A | A |
| Heat treatment | | 540-5 | — | — | — | 540-5 | — |
| conditions | | | | | | | |
| (temperature | | | | | | | |
| [° C.] - time [hr]) | | | | | | | |
| Precipitated crystalline | | Li₂SiO₃ | | | | Li₂SiO₃ | |
| phase | | and other | | | | | |
| Transparency | | B | | | | B | |
| Vickers hardness [HV] | | — | | | | — | |
| Fracture toughness value | | | | | | | |
| [MPa · m]^{1/2} | | | | | | | |
| Chemical strengthening | | | | | | | |
| treatment conditions | | | | | | | |
| (melt - | | | | | | | |
| temperature [° C.] - | | | | | | | |
| time [hr]) | | | | | | | |
| Surface compressive | | | | | | | |
| stress value | | | | | | | |
| [MPa] | | | | | | | |
| Compressive | | | | | | | |
| stress depth | | | | | | | |
| [μm] | | | | | | | |

It is clear from Table 1 that the glass ceramics according to Examples 1 to 20 have sufficiently low viscosity in the melt state, transparency, and high internal strength (strength of the material itself). Furthermore, on the glass ceramics according to Examples 1 to 20, a compressive stress layer with a surface compressive stress value of 400 MPa or higher can be formed by chemical strengthening, i.e., effective chemical strengthening by ion exchange is possible.

In contrast, it is clear from Table 2 that in Comparative Examples 1 to 15, either vitrification was not possible to begin with during preparation of the glass ceramic, or even if vitrification did take place, viscosity in the melt state, transparency, or effective chemical strengthening by ion exchange was not achieved.

### INDUSTRIAL APPLICABILITY

According to the present disclosure, a transparent glass ceramic that has sufficiently low viscosity in the melt state, allows effective chemical strengthening by ion exchange, and has high internal strength, and a manufacturing method thereof, can be provided. According to the present disclosure, a device using the above-described glass ceramic can also be provided.

1. A glass ceramic having a composition comprising:
in mol % by oxide equivalent,
SiO₂: 55% or more to 70% or less;
B₂O₃: over 0% to 10% or less;
P₂O₅: over 0% to 5% or less;
Li₂O: 18% or more to 30% or less;
Na₂O: over 3% to 10% or less;
K₂O: 0% or more to 5% or less; and
ZrO₂: over 0% to 5% or less,
wherein the glass ceramic substantially does not comprise Al₂O₃.

2. The glass ceramic according to claim 1, wherein a temperature at which viscosity of the glass ceramic in a melt state exhibits a value of 100 dPa·s is 1200° C. or less.

3. The glass ceramic according to claim 1, comprising at least one of a Li₂SiO₃ crystalline phase and a Li₂Si₂O₅ crystalline phase.

4. The glass ceramic according to claim 1, wherein at a thickness of 1 mm, the glass ceramic has a transmittance of 85% or more with respect to 400 nm wavelength light.

5. The glass ceramic according to claim 1, wherein Vickers hardness of the glass ceramic is 600 HV or more.

6. The glass ceramic according to claim 1, wherein a fracture toughness value of the glass ceramic is 1.00 MPa·m^{1/2} or more.

7. The glass ceramic according to claim 1, comprising a compressive stress layer on a surface of the glass ceramic.

8. The glass ceramic according to claim 7, wherein the compressive stress layer has a surface compressive stress value of 400 MPa or more and a compressive stress depth of 50 μm or more.

9. A method for manufacturing glass ceramic, the method comprising:
preparing a glass composition having a composition including
in mol % by oxide equivalent,
SiO₂: 55% or more to 70% or less,
B₂O₃: over 0% to 10% or less,
P₂O₅: over 0% to 5% or less,
Li₂O: 18% or more to 30% or less,
Na₂O: over 3% to 10% or less,
K₂O: 0% or more to 5% or less, and
ZrO₂: over 0% to 5% or less,
the glass composition substantially not including Al₂O₃; and
applying crystallization treatment to the glass composition to obtain a glass ceramic.

10. A device using the glass ceramic according to claim 1.

11. The glass ceramic according to claim 2, comprising at least one of a Li₂SiO₃ crystalline phase and a Li₂Si₂O₅ crystalline phase.

12. The glass ceramic according to claim 2, wherein at a thickness of 1 mm, the glass ceramic has a transmittance of 85% or more with respect to 400 nm wavelength light.

13. The glass ceramic according to claim 2, wherein Vickers hardness of the glass ceramic is 600 HV or more.

14. The glass ceramic according to claim 2, wherein a fracture toughness value of the glass ceramic is 1.00 MPa·m^{1/2} or more.

15. The glass ceramic according to claim 2, comprising a compressive stress layer on a surface of the glass ceramic.

16. The glass ceramic according to claim 15, wherein the compressive stress layer has a surface compressive stress value of 400 MPa or more and a compressive stress depth of 50 μm or more.

17. A device using the glass ceramic according to claim 2.
